(19) United States
(12) Patent Application Publication
(10) Pub. No.: US 2026/0195921 A1
(43) Pub. Date: Jul. 9, 2026

(54) UNSUPERVISED DEPTH FEATURES FOR THREE-DIMENSIONAL POSE ESTIMATION

(71) Applicant: Hinge Health, Inc., San Francisco, CA (US)

(72) Inventor: Abel Gonzalez Garcia, Montreal (CA)

(21) Appl. No.: 19/556,498

(22) Filed: Mar. 4, 2026

Related U.S. Application Data
(63) Continuation of application No. PCT/US24/45184, filed on Sep. 4, 2024.
(60) Provisional application No. 63/580,647, filed on Sep. 5, 2023.

(51) Int. Cl. G06T 7/73; G06N 3/045

(52) U.S. Cl. CPC G06T 7/73; G06N 3/045; G06T 2207/20081; G06T 2207/20084; G06T 2207/30008

(57) ABSTRACT

Introduced here are computer-implemented platforms (also referred to as “motion monitoring platforms”) that are designed to estimate three-dimensional (3D) poses. The motion monitoring platform obtains an image and applies a pose estimation model to the image by inputting the image to a first sub-network that extracts a two-dimensional (2D) pose and unsupervised depth features from the image. The 2D pose, augmented with the unsupervised depth features, is input into a second sub-network that is trained to regress 3D bones based on the input. The motion monitoring platform uses the 3D bones to determine an estimated pose of an individual in the image.

### CROSS-REFERENCE TO RELATED APPLICATIONS

This application is a continuation of International Application No.: PCT/US2024/045184, filed September 4, 2024, titled “UNSUPERVISED DEPTH FEATURES FOR THREE-DIMENSIONAL POSE ESTIMATION”, which claims priority to U.S. Provisional Application No. 63/580,647, titled “Unsupervised Depth Features for Three-Dimensional Pose Estimation” and filed on September 5, 2023, the entirety of each is incorporated herein by reference.

### TECHNICAL FIELD

Various embodiments concern computer programs and associated computer-implemented techniques for estimating pose of a living body and providing appropriate feedback to promote completion of physical activities.

### BACKGROUND

Pose estimation (also called “pose detection”) is an active area of study in the field of computer vision. Over the last several years, tens – if not hundreds – of different approaches have been proposed in an effort to solve the problem of pose detection. Many of these approaches rely on machine learning due to its programmatic approach to learning what constitutes a pose.

As a field of artificial intelligence, computer vision enables machines to perform image processing tasks with the aim of imitating human vision. Pose estimation is an example of a computer vision task that generally includes detecting, associating, and tracking the movements of a person. This is commonly done by identifying “key points” that are semantically important to understanding pose. Examples of key points include “head,” “left shoulder,” “right shoulder,” “left knee,” and “right knee.” Insights into posture and movement can be drawn from analysis of these key points.

### BRIEF DESCRIPTION OF THE DRAWINGS

FIG. 1 illustrates an example of a network environment that includes a motion monitoring platform.

FIG. 2 illustrates an example of a computing device able to implement a pose estimation model of a motion monitoring platform.

FIGS. 3A-B depict digital images of an individual overlaid with two-dimensional projections of the individual’s poses.

FIG. 4 depicts a block diagram representative of the architecture of a pose estimation model.

FIG. 5 depicts a flow diagram of a process for determining an estimated pose using a pose estimation model.

FIG. 6 includes a block diagram illustrating an example of a processing system in which at least some operations described herein can be implemented.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Over the last several years, significant advances have been made in the field of computer vision. This has resulted in the development of sophisticated pose estimation programs (also called “pose estimators” or “pose predictors”) that are designed to perform pose estimation in either two dimensions or three dimensions. Two-dimensional (“2D”) pose estimators predict the 2D spatial locations of key points, generally through the analysis of the pixels of a single digital image (or simply “image”). Three-dimensional (“3D”) pose estimators predict the 3D spatial arrangement of key points, generally through the analysis of the pixels of multiple images, for example, consecutive frames in a video, or a single image in combination with another type of data generated by, for example, an inertial measurement unit (“IMU”) or Light Detection and Ranging (“LiDAR”) unit.

Pose estimators – both 2D and 3D – continue to be applied to different contexts, and as such, continue to be used to help solve different problems. One problem for which pose estimators have proven to be particularly useful is monitoring the performance of physical activities. Consider, for example, a scenario where an individual is instructed or prompted to perform a physical activity by a computer program. By applying a pose estimator to images of the individual, the computer program can glean insight into performance of the physical activity. Historically, the individual may have instead been asked to summarize her performance of the physical activity (e.g., in terms of difficulty); however, this type of manual feedback tends to be inaccurate and inconsistent. Due to their consistent, programmatic nature, pose estimators allow for more accurate monitoring of performances of physical activities.

This is especially important if the pose estimator is responsible for monitoring physical activities that have meaningful real-world impact, such as on the health and wellness of the individual responsible for performing the physical activities. Exercise therapy is an intervention technique that utilizes physical activities as the principal treatment for addressing the symptoms of musculoskeletal (“MSK”) conditions, such as acute physical ailments and chronic physical ailments. Exercise therapy programs (or simply “programs”) generally involve a plan for performing physical activities during exercise therapy sessions (or simply “sessions”) that occur on a periodic basis. Normally, the purpose of a program is to either restore normal MSK functionality or reduce the pain caused by a physical ailment, which may have been caused by injury or disease.

Programs generally explain, either audibly or visually, how an individual (also called a “user,” “patient,” or “participant”) should perform physical activities to achieve a therapeutic goal. However, individuals can – and often do – struggle to adhere to their respective programs unless consistently engaged, which is difficult to achieve if the program does not accurate determine what an individual is doing with her body (e.g., her pose).

Introduced here is an approach to determining an estimated pose of an individual, which can be displayed to the individual to reflect her body positioning during one or more physical activities. As further discussed below, a pose estimation model (also called a “pose model,” “pose estimator,” or simply “model”) that includes multiple sub-networks, each responsible for a different task or set of tasks, may be used in additional pose estimation contexts. For example, the approach can be used to create instructions of how to perform a ballerina’s dance based on a sequence of her poses. In another example, the approach can be used to suggest an emotion or other nonverbal communication being conveyed by an individual’s pose. The approach leverages a pose estimation model to output data representing an estimated pose of an individual based on an input image of an individual. Simply put, the approach improves pose estimation for use by a motion monitoring platform.

More particularly, the approach leverages a pose estimation model that uses unsupervised depth features to estimate pose. The pose estimation model can include two sub-networks. The first sub-network can extract a 2D pose and one or more unsupervised depth feature from the image and augment the 2D pose with the unsupervised depth features. During training of the first sub-network, the coordinates of 2D poses may be explicitly supervised while the unsupervised depth features may not be. The second sub-network can regress a 3D skeletal structure (also called a “3D skeletal frame”) comprised of multiple bones based on the 2D pose augmented with the unsupervised depth features, and these bones can be used with the 2D pose and unsupervised depth features for further training of the first sub-network, second sub-network, or first and second sub-networks.

Using unsupervised depth features in this manner provides the second sub-network with a concise representation of visual features that is comparable to the coordinates of the 2D pose. As a result, the pose estimation model is computationally “lightweight” compared to conventional models and able to use more information from the image than merely coordinates for the 2D pose. In experiments, the pose estimation model has been shown to have better performance than conventional pose estimators for the task of monocular 3D pose estimation. Moreover, the output of the pose estimation model may be in the form of a single 3D pose, whereas conventional pose estimators generally output multiple 3D poses. Such multi-output approaches are evaluated by selecting the optimal pose a posteriori by using the knowledge of the ground-truth pose, and so the approaches’ actual utility is not guaranteed in practice. Additionally, these approaches are more computationally demanding given the extra outputs, compared to the pose estimation model described herein.

For the purpose of illustration, embodiments may be described with reference to exercises that are performed during sessions as part of a program. However, the motion monitoring platform could be designed to monitor performance of other physical activities, such as sporting activities, cooking activities, art activities, and the like. Accordingly, the approach described herein could be used to provide personalized feedback regarding performance of nearly any physical activity.

Moreover, embodiments may be described in the context of computer-executable instructions for the purpose of illustration. However, aspects of the approach could be implemented via hardware or firmware instead of, or in addition to, software. As an example, the motion monitoring platform may be embodied as a computer program that offers support for completing exercises during sessions as part of a program, determines which physical activities are appropriate for a user given performance during past sessions, and enables communication between the user and one or more coaches. The term “coach” may be used to generally refer to individuals who prompt, encourage, or otherwise facilitate engagement by users with the motion monitoring platform. Coaches are generally not healthcare professionals but could be in some embodiments.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

### Overview of Motion Monitoring Platform

A motion monitoring platform may be responsible for monitoring the motion of an individual (also called a “user,” “patient,” or “participant”) through analysis of images that contain her and are captured as she completes a physical activity. As an example, the motion monitoring platform may guide the user through exercise therapy sessions (or simply “sessions”) that are performed as part of an exercise therapy program (or simply “program”). As part of the program, the user may be requested to engage with the motion monitoring platform on a periodic basis. The frequency with which the user is requested to engage with the motion monitoring platform may be based on factors such as the anatomical region for which therapy is needed, the MSK condition for which therapy is needed, the difficulty of the program, the age of the user, the amount of progress that has been achieved, and the like.

As the user performs exercises, she may be recorded by a camera of a computing device. Normally, the camera is part of the computing device on which the motion monitoring is executed or accessed. For example, in order to initiate a session, the user may initiate a mobile application that is stored on, and executable by, her mobile phone or tablet computer, and the mobile application may instruct the user to position her mobile phone or tablet computer in such a manner that one of its cameras can record her as exercises are performed. Note that, in some embodiments, the camera is part of another computing device. For example, the camera may be included in a peripheral computing device, such as a web camera (also called a “webcam”), that is connected to the computing device. By examining the images that are output by the camera, the motion monitoring platform can monitor performance the exercises by estimating the pose of the user over time.

As mentioned above, the motion monitoring platform could alternatively estimate pose in contexts that are unrelated to healthcare, for example, to improve technique. As an example, the motion monitoring platform may estimate pose of an individual while she completes a sporting activity (e.g., performs a dance move, performs a yoga move, shoots a basketball, throws a baseball, swings a golf club), a cooking activity, an art activity, etc. Accordingly, while embodiments may be described in the context of a user who completes an exercise during a session as part of a program, the features of those embodiments may be similarly applicable to individuals performing other types of physical activities. Individuals whose performances of physical activities are analyzed may be referred to as “users” of the motion monitoring platform, even if these individuals have little to no opportunity to interact with the motion monitoring platform.

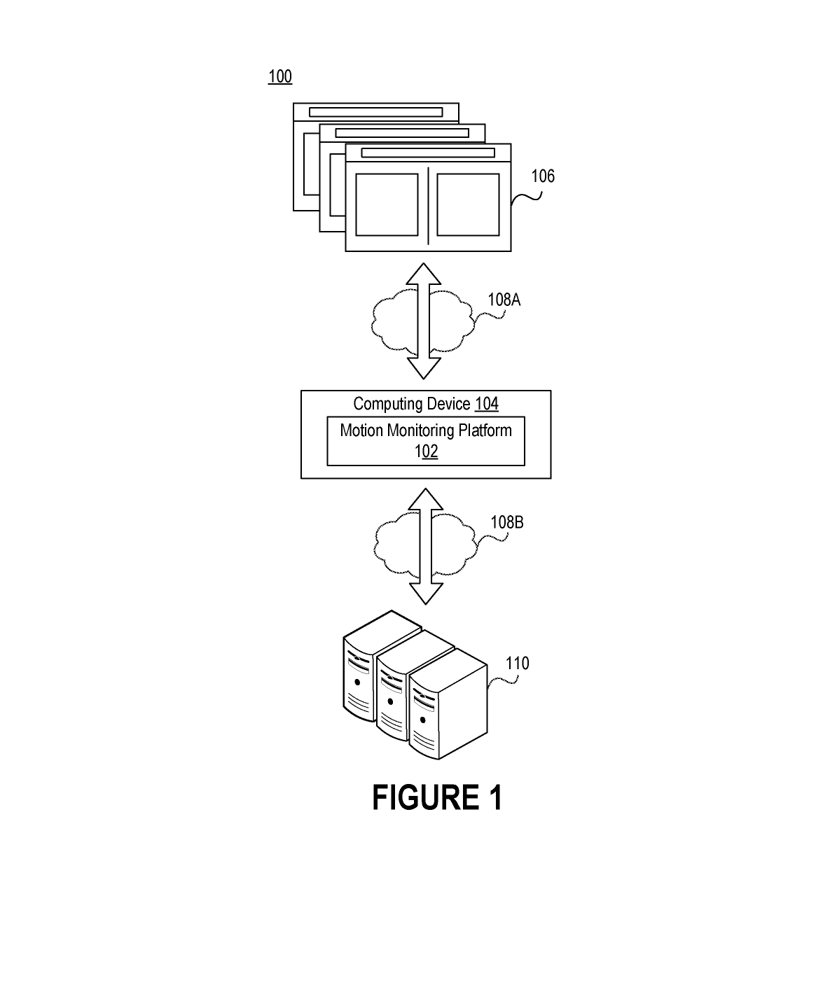

FIG. 1 illustrates a network environment 100 that includes a motion monitoring platform 102 that is executed by a computing device 104. Users can interact with the motion monitoring platform 102 via interfaces 106. For example, users may be able to access interfaces that are designed to guide them through physical activities, indicate progress, present feedback, etc. As another example, users may be able to access interfaces through which information regarding completed physical activities can be reviewed, feedback can be provided, etc. Thus, interfaces 106 may serve as informative spaces, or the interfaces 106 may serve as collaborative spaces through which users and coaches can communicate with one another.

As shown in FIG. 1, the motion monitoring platform 102 may reside in a network environment 100. Thus, the computing device on which the motion monitoring platform 102 is executing may be connected to one or more networks 106A-B. Depending on its nature, the computing device 104 could be connected to a personal area network (“PAN”), local area network (“LAN”), wide area network (“WAN”), metropolitan area network (“MAN”), or cellular network. For example, if the computing device 104 is a mobile phone, then the computing device 104 may be connected to a computer server of a server system 110 via the Internet. As another example, if the computing device 104 is a computer server, then the computing device 104 may be accessible to users via respective computing devices that are connected to the Internet via LANs.

The interfaces 106 may be accessible via a web browser, desktop application, mobile application, or another form of computer program. For example, to interact with the motion monitoring platform 102, a user may initiate a web browser on the computing device 104 and then navigate to a web address associated with the motion monitoring platform 102. As another example, a user may access, via a desktop application or mobile application, interfaces that are generated by the motion monitoring platform 102 through which she can select physical activities to complete, review analyses of her performance of the physical activities, and the like. Accordingly, interfaces generated by the motion monitoring platform 102 may be accessible via various computing devices, including mobile phones, tablet computers, desktop computers, wearable electronic devices (e.g., watches or fitness accessories), virtual reality systems, augmented reality systems, and the like.

Generally, the motion monitoring platform 102 is hosted, at least partially, on the computing device 104 that is responsible for generating the digital images to be analyzed, as further discussed below. For example, the motion monitoring platform 102 may be embodied as a mobile application executing on a mobile phone or tablet computer. In such embodiments, the instructions that, when executed, implement the motion monitoring platform 102 may reside largely or entirely on the mobile phone or tablet computer. Note, however, that the mobile application may be able to access a server system 110 on which other aspects of the motion monitoring platform 102 are hosted.

In some embodiments, aspects of the motion monitoring platform 102 are executed by a cloud computing service operated by, for example, Amazon Web Services®, Google Cloud Platform^{TM}, or Microsoft Azure®. Accordingly, the computing device 104 may be representative of a computer server that is part of a server system 110. Often, the server system 110 is comprised of multiple computer servers. These computer servers can include information regarding different physical activities; computer-implemented models (or simply “models”) that indicate how anatomical regions should move when a given physical activity is performed; computer-implemented templates (or simply “templates”) that indicate how anatomical regions should be positioned when partially or fully engaged in a given physical activity; algorithms for processing image data from which spatial position of anatomical regions can be computed, inferred, or otherwise determined; user data such as name, age, weight, ailment, enrolled program, duration of enrollment, and number of physical activities completed; and other assets.

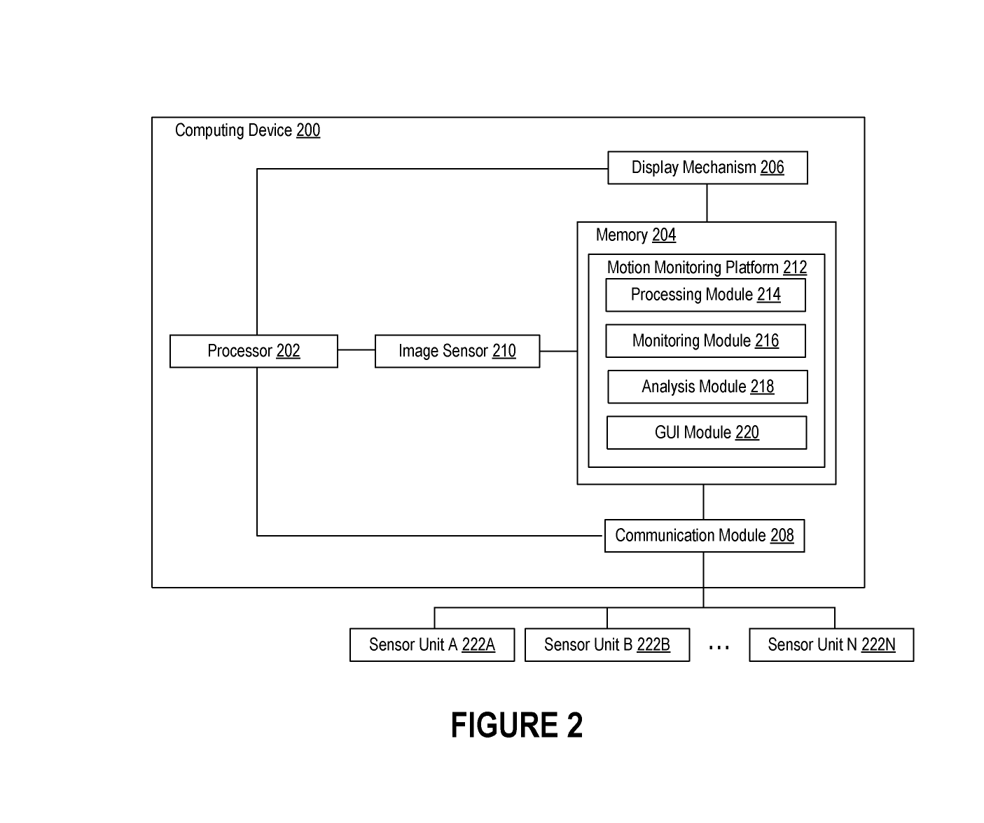

FIG. 2 illustrates an example of a computing device 200 that is able to execute a motion monitoring platform 212. As mentioned above, the motion monitoring platform 212 can facilitate the performance of physical activities by a user, for example, by providing instruction or encouragement based on the user’s estimated pose(s). As shown in FIG. 2, the computing device 200 can include a processor 202, memory 204, display mechanism 208, communication module 208, image sensor 210A, audio output mechanism 222, and audio input mechanism 224. Each of these components is discussed in greater detail below.

Those skilled in the art will recognize that different combinations of these components may be present depending on the nature of the computing device 200. For example, if the computing device 200 is a computer server that is part of a server system (e.g., server system 110 of FIG. 1), then the computing device 200 may not include the display mechanism 206, image sensor 210A, audio output mechanism 222, or audio input mechanism 224, though the computing device 200 may be communicatively connectable to another computing device that does include a display mechanism, an image sensor, an audio output mechanism, or an audio input mechanism.

The processor 202 can have generic characteristics similar to general-purpose processors, or the processor 202 may be an application-specific integrated circuit (ASIC) that provides control functions to the computing device 200. As shown in FIG. 2, the processor 202 can be coupled to all components of the computing device 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the modules of the motion monitoring platform 212) and produced, retrieved, or obtained by the other components of the computing device 200. For example, data received by the communication module 208 from the image sensor 210 (via the processor 202) or sensor units 222A-N may be stored in the memory 204, or data produced by the image sensor 210 may be stored in the memory 204. Note that the memory 204 is merely an abstract representation of a storage environment. The memory 204 could be comprised of actual memory integrated circuits (also referred to as “chips”).

The display mechanism 206 can be any mechanism that is operable to visually convey information to a user. For example, the display mechanism 206 may be a panel that includes light-emitting diodes (“LEDs”), organic LEDs, liquid crystal elements, or electrophoretic elements. In some embodiments, the display mechanism 206 is touch sensitive. Thus, a user may be able to provide input to the motion monitoring platform 212 by interacting with the display mechanism 206. Alternatively, the user may be able to provide input to the motion monitoring platform 312 through some other control mechanism.

The communication module 208 may be responsible for managing communications external to the computing device 200. For example, the communication module 208 may be responsible for managing communications with other computing devices (e.g., server system 210 of FIG. 1, or a camera peripheral such as video camera or webcam). The communication module 208 may be wireless communication circuitry that is designed to establish communication channels with other computing devices. Examples of wireless communication circuitry include 2.4 gigahertz (“GHz”) and 5 GHz chipsets compatible with Institute of Electrical and Electronics Engineers (“IEEE”) 802.11 - also referred to as “Wi-Fi chipsets.” Alternatively, the communication module 208 may be representative of a chipset configured for Bluetooth®, Near Field Communication (“NFC”), and the like. Some computing devices – like mobile phones and tablet computers – are able to wirelessly communicate via separate channels. Accordingly, the communication module 208 may be one of multiple communication modules implemented in the computing device 200. As an example, the communication module 208 may initiate and then maintain one communication channel with a camera peripheral (e.g., via Bluetooth), and the communication module 208 may initiate and then maintain another communication channel with a server system (e.g., via the Internet).

The nature, number, and type of communication channels established by the computing device 200 – and more specifically, the communication module 208 – may depend on the sources from which data is received by the motion monitoring platform 212 and the destinations to which data is transmitted by the motion monitoring platform 212. Assume, for example, that the computing device 200 is representative of a mobile phone or tablet computer that is associated with (e.g., owned by) a user. In some embodiments the communication module 208 may only externally communicate with a computer server, while in other embodiments the communication module 208 may also externally communicate with a source from which to receive image data. The source could be another computing device (e.g., a mobile phone or camera peripheral that includes an image sensor 210B) to which the mobile device is communicatively connected. Image data could be received from the source even if the mobile phone generates its own image data. Thus, image data could be acquired from multiple sources, and these image data may correspond to different perspectives of the user performing a physical activity. Regardless of the number of sources, image data – or analyses of the image data – may be transmitted to the computer server for storage in a digital profile that is associated with the user. The same may be true if the motion monitoring platform 212 only acquires image data generated by the image sensor 210A. The image data may initially be analyzed by the motion monitoring platform 212, and then the image data – or analyses of the image data – may be transmitted to the computer server for storage in the digital profile.

The image sensor 210A may be any electronic sensor that is able to detect and convey information in order to generate images, generally in the form of image data (also called “pixel data”). Examples of image sensors include charge-coupled device (“CCD”) sensors and complementary metal-oxide semiconductor (“CMOS”) sensors. The image sensor 210A may be part of a camera module (or simply “camera”) that is implemented in the computing device 200. In some embodiments, the image sensor 210A is one of multiple image sensors implemented in the computing device 200. For example, the image sensor 210A could be included in a front- or rear-facing camera on a mobile phone. Alternatively, the image sensor 210A may be externally connected to the computing device 200 such that the image sensor 210A captures image data of an environment and sends the image data to the to the motion monitoring platform 212.

For convenience, the motion monitoring platform 112 may be referred to as a computer program that resides within the memory 204. However, the motion monitoring platform 212 could be comprised of software, firmware, or hardware implemented in, or accessible to, the computing device 200. In accordance with embodiments described herein, the motion monitoring platform 212 may include a processing module 214, pose estimating module 216, analysis module 218, and graphical user interface (“GUI”) module 220. These modules can be an integral part of the motion monitoring platform 212. Alternatively, these modules can be logically separate from the motion monitoring platform 212 but operate “alongside” it. Together, these modules may enable the motion monitoring platform 212 to programmatically monitor motion of users during the performance of physical activities, such as exercises, through analysis of images generated by the image sensor 210.

The processing module 214 can process image data obtained from the image sensor 210A over the course of a session. The image data may be used to infer a spatial position or orientation of one or more anatomical regions as further discussed below. The image data may be representation of a series of images. These images may be discretely captured by the image sensor 210A over time, such that each image captured the user at different stages of performing a physical activity. In some embodiments, these images may be representative of frames of a video that is captured by the image sensor 210. In such embodiments, the image data could also be called “video data.”

The image data may be used to infer a spatial position of one or more anatomical regions (e.g., an estimated pose of a user) as further discussed below. For example, the processing module 214 may perform operations (e.g., filtering noise, changing contrast, reducing size) to ensure that the data can be handled by the other modules of the motion monitoring platform 212. As another example, the processing module 214 may temporally align the data with data obtained from another source (e.g., another image sensor) if multiple data are to be used to establish the spatial position of the anatomical regions of interest.

Moreover, the processing module 214 may be responsible for processing information input by users through interfaces generated by the GUI module 220. For example, the GUI module 220 may be configured to generate a series of interfaces that are presented in succession to a user as she completes physical activities as part of a session. On some or all of these interfaces, the user may be prompted to provide input. For example, the user may be requested to indicate (e.g., via a verbal command or tactile command provided via, for example, the display mechanism 206) that she is ready to proceed with the next physical activity, that she completed the last physical activity, that she would like to temporarily pause the session, etc. These inputs can be examined by the processing module 214 before information indicative of these inputs is forwarded to another module.

The pose estimating module 216 (or simply “estimating module”) may be responsible for estimating the pose of the user through analysis of image data, in accordance with the approach further discussed below. Specifically, the estimating module 216 can create, based on an image (e.g., generated by the image sensor 210A or image sensor 210B), a skeletal frame that specifies a spatial position of each of multiple anatomical regions. For example, the estimating module 216 can apply a computer-implemented model (or simply “model”) referred to as a pose estimation model or pose estimator to the image, so as to produce the skeletal frame. In some embodiments the pose estimator is designed and trained to identify a predetermined number of joints (e.g., left and right wrist, left and right elbow, left and right shoulder, left and right hip, left and right knee, left and right ankle, or any combination thereof), while in other embodiments the pose estimator is designed and trained to identify all joints that are visible in the image provided as input. The pose estimator could be a neural network that when applied to the image, analyzes the pixels to independently identify digital features that are representative of each anatomical region of interest.

The analysis module 218 may be responsible for establishing the locations of anatomical regions of interest based on the outputs produced by the estimating module 216. Referring again to the aforementioned examples, the analysis module 216 could establish the locations of joints based on an analysis of the skeletal frame. Moreover, the analysis module 218 may be responsible for determining appropriate feedback for the user based on the outputs produced by the estimating module 216, in accordance with the approach further discussed below. Specifically, the analysis module 218 may determine an appropriate personalized recommendation for the user based on her current position, and a determination as to how her current position compares to a template that is associated with the physical activity that she has been instructed to perform.

Other modules could also be included in some embodiments. For example, the motion monitoring platform 212 may include a training module (not shown) that is responsible for training the pose estimator that is employed by the pose estimating module 216. As another example, the motion monitoring platform 212 may include a template generating module (not shown) that is responsible for generating templates that are used by the analysis module 218 to determine which recommendations, if any, are appropriate for a user given her current position.

Similarly, other components could be implemented in, or accessible to, the computing device 200 in some embodiments. For example, some embodiments of the computing device 200 include an audio output mechanism 222 and/or an audio input mechanism 224. The audio output mechanism 222 may be any apparatus that is able to convert electrical impulses into sound. One example of an audio output mechanism is a loudspeaker (or simply “speaker”). Meanwhile, the audio input mechanism 324 may be any apparatus that is able to convert sound into electrical impulses. One example of an audio input mechanism is a microphone. Together, the audio output and input mechanisms 222, 224 may enable feedback, such as personalized recommendation as further discussed below, to be audibly provided to the user. Assume, for example, that the user has been instructed to perform a physical activity while being recorded by the image sensor 210A. In such a scenario, the user may be audibly encouraged – in a personalized manner – via the audio output mechanism 222.

### Overview of Pose Estimation Model

Various attempts have been made to improve pose estimation for use in motion monitoring platforms. Consider, for example, an exercise therapy program that requires exercises be performed by an individual to achieve a therapeutic goal. The individual may perform the exercises, but if the motion monitoring platform inaccurately estimates what poses the individual is doing or the exercises, the individual may not receive useful feedback for the exercise therapy program.

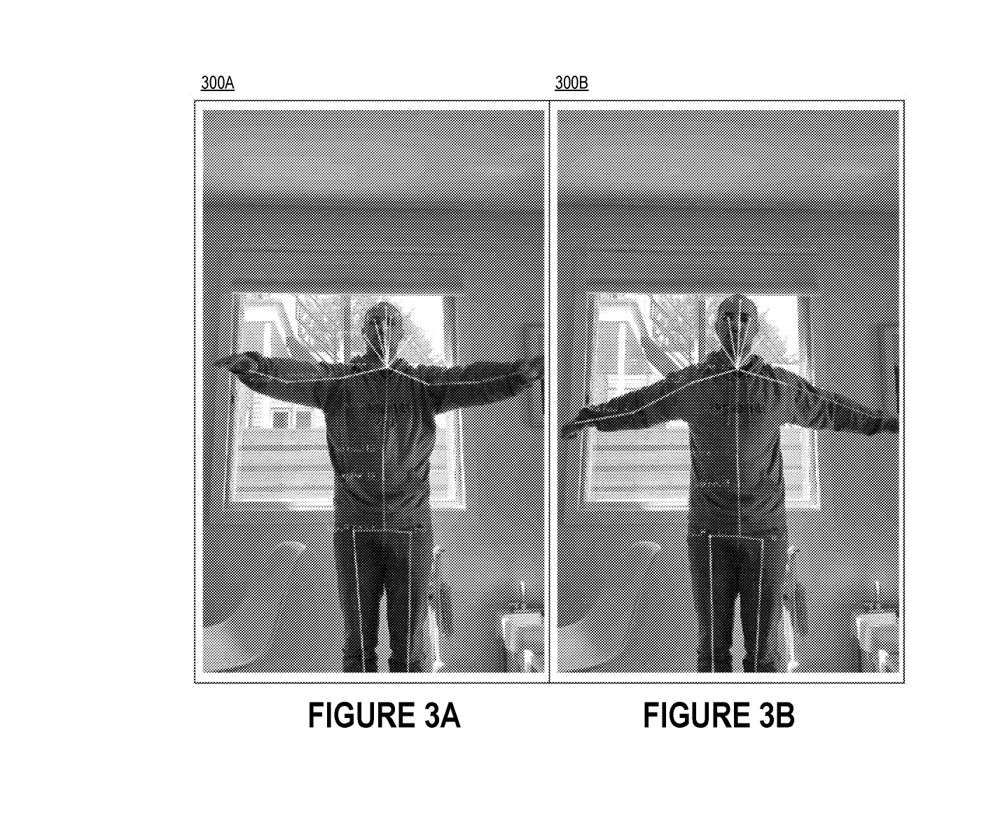

Three-dimensional (3D) pose estimation is commonly tackled using lifting-based approaches, which involve estimating 3D poses by adding depth to externally estimated two-dimensional (2D) key points. These approaches typically offer highest accuracy compared to other approaches and benefit from strong signal provided by high quality 2D pose estimation, which is an extensively researched computer vision task that has been matured over recent years. However, lifting-based approaches are bounded by how accurately 3D poses can be estimated in a monocular, single-frame setting. Said another way, previous lifting-based approaches are limited to inherent ambiguity between 2D and 3D poses. For instance, the same 2D pose can correspond to multiple 3D poses. FIGS. 3A and 3B depict an example of this phenomenon.

FIG. 3A shows an individual with his arms extended outward and forward from his body and a 2D projection of his joint and bone locations overlaid on his body. FIG. 3B shows the individual with his arms extended outward and backward from his body and a 2D projection of his joint and bone locations overlaid on his body. Despite the individual’s arms being in different poses in FIGS. 3A and 3B, the 2D projections are very similar to one another. For example, the individual’s arms appear shortened in both figures. If these 2D projections were simply “lifted” into three dimensions in accordance with a conventional approach, the ambiguity between the difference in poses could cause the resulting 3D poses to also look similar, if not the same, despite the difference in positioning of the individual’s arms (e.g., forward in FIG. 3A and backward in FIG. 3B). Note that the term “lifting” may refer to the process by which 2D key points are translated into 3D key points using a set of rules, algorithms, or a machine learning model. Various attempts have been made to improve the accuracy of these translation mechanisms, generally without much success as accuracy tends to be poor – especially in situations like the ones shown in FIGS. 3A-B. Thus, more information than just 2D joint and bone locations (e.g., 2D pose) are needed to distinguish between different 3D poses.

The pose estimation model described herein is able to learn depth information from images to inform 3D bone regression with joint depth information. The pose estimation model can do this by allocating additional feature maps (e.g., unsupervised depth features) complementary to the maps corresponding to x- and y-axes, where the content of the maps are unsupervised. This allows the pose estimation model to learn effective visual features for bone regression, which results in superior 3D pose estimations compared to a model with architecture that only uses 2D (e.g., x- and y-coordinate) features. Said another way, the use of unsupervised depth features decreases the ambiguity between 2D and 3D poses by providing visual support (e.g., the unsupervised depth features) to the pose estimation model.

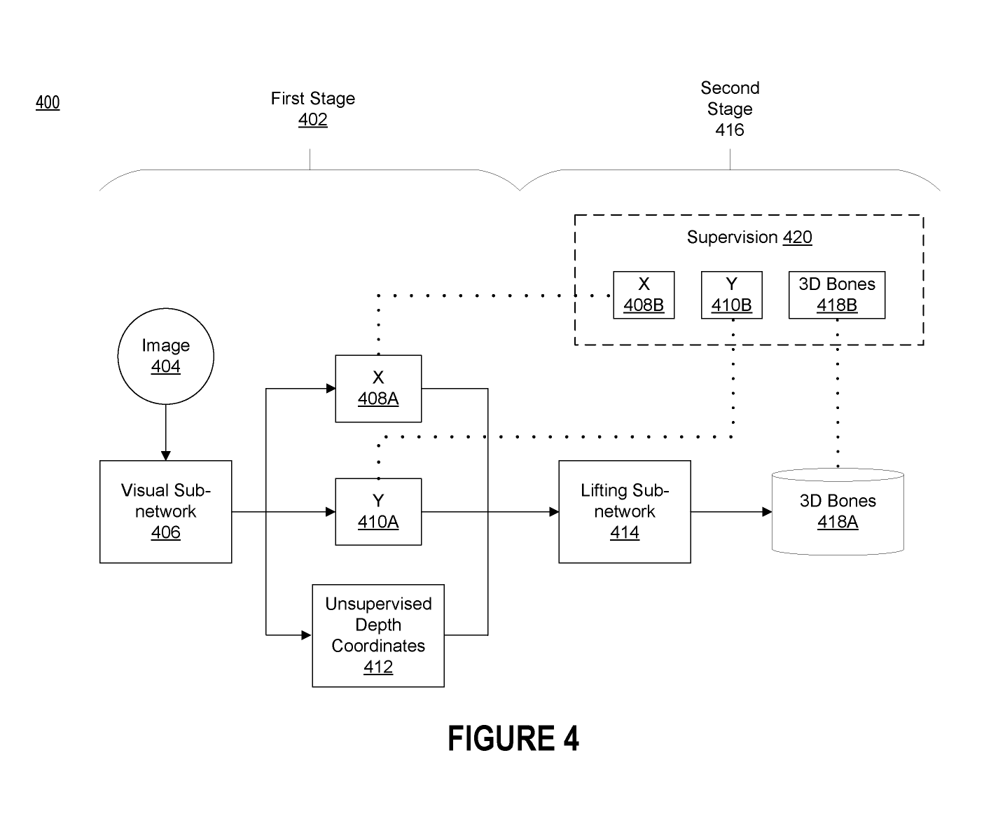

FIG. 4 depicts a block diagram representative of the architecture 400 of the pose estimation model. At a high level, the pose estimation model may be representative of a machine learning model that is designed and trained to estimate pose of an individual based on analysis of an image that includes the individual. Note that the pose estimation model may be stored in, or accessible to, the analysis module 218 of FIG. 2. The architecture 400 can be divided into separate internal stages, where the pose estimation model applies a different sub-network at each stage and uses unsupervised depth coordinates 412 to determine 3D key points corresponding to an individual’s pose. In some embodiments, the architecture 400 of the pose estimation model includes alternative or additional blocks to those shown in FIG. 4, such as a training engine or user interface module.

In the first stage 402, the motion monitoring platform 102 can receive an image 404 that depicts an individual in an environment. In some instances, the motion monitoring platform can receive images, video, or other visual data in addition to, or instead of, the image 404. The motion monitoring platform 102 can request the image 404 from an image sensor 210 on a computing device 200 located within the environment of the individual. In response, the image sensor 210 to capture the image 404 in real time and send the image 404 to the motion monitoring platform 102. The motion monitoring platform 102 can also receive the image 404 from a sensor unit 222 external to the computing device 200 running the motion monitoring platform 102. For example, the motion monitoring platform 102 may be running on a coach’s computing device 200 and receive the image 404 from a sensor unit 222 on the individual’s computing device. In some instances, the computing device 200 may receive the image 404 from an external computing device 200 that received the image 404 from another external source.

The motion monitoring platform 102 inputs the image 404 to a visual sub-network 406. The visual sub-network 406 is a convolutional neural network that can extract intermediate 2D poses from images (or other image data) in the form of 2D key points. Key points are distinctive features of the image data that can be detected repeatedly despite changes in scale, resolution, noise, illumination, orientation, and perspective of the image data (e.g., the key points are robust against image transformations and are scale independent). Each key point may be represented by x-coordinates 408A and y-coordinates 410A that correspond to anatomical landmarks – like joints and bones – on a 2D spatial plane defined by the image. The visual sub-network 406 can complement (e.g., augment) each pairing of x- 408A and y-coordinates 410A with an additional coordinate that represents depth (henceforth referred to as unsupervised depth coordinate 412). For example, the visual sub-network 406 can extract a set of x- 408A and y-coordinates 410A that together correspond to joints or bones of the individual as shown in the image 404 and can determine an unsupervised depth feature 412 for each pair of x- and y-coordinates corresponding to a joint or bone.

The unsupervised depth coordinates 412 are essentially a concise representation of visual depth features from the image 404 translated into a dimension that is comparable to the x- and y-dimensions. During training of the pose estimation model, the x- 408A and y-coordinates 410A are supervised but the unsupervised depth coordinate 412 is not explicitly supervised. Use of the depth coordinate allows the pose estimation model to learn what depth features in images are useful for 3D pose estimation without being forced to store the depth features.

The lifting sub-network 414 can receive the augmented 2D pose and converts the augmented 2D pose to coordinates of 3D bones 418A (and/or joints) of the individual. The 3D bones can correspond to a skeletal frame of the individual positioned based on the image. The lifting sub-network 414 may be a neural network with a stack of fully connected layers (e.g., a fully connected lifting architecture) or another machine learning model and can use exemplar-matching, regression, probabilistic inference, or another suitable method to lift 2D key points (e.g., the augmented 2D pose) into 3D key points (e.g., the 3D bones 418A). In some instances, the lifting sub-network 414 can be structured in a Graph Convolutional Network (“GCN”) architecture or a Transformer architecture, which follows an encoder-decoder structure but does not rely on recurrence and convolutions in order to generate an output.

After the second stage 416, the motion monitoring platform 102 receives the 3D bones 418A from the pose estimation model 318 and estimates the individual’s pose based on the 3D bones 418A. For example, the 3D bones 418A can be represented as a series of 3D (e.g., x-, y-, and z-coordinates) points that depict an estimated outline of the individual’s bones (and joints) and the motion monitoring platform 102 can access a database describing a range of 3D points that result in one or more poses. For example, plotting the 3D bones 418A may result in an outline showing that the individual’s legs are bent at 90-degree angles and her arms are extended forward. In this example, the motion monitoring platform 102 can estimate that the individual is doing a squat or sitting in a chair with her arms on the chair’s armrests.

The motion monitoring platform 102 can train the visual sub-network 406 and lifting sub-network 414 for the ultimate task of 3D pose estimation. During training, the x-coordinates 408B, y-coordinates 410B, and 3D bones 418B are supervised 420, such that the sub-networks receive the 3D bones 418B labeled with the x- 408B and y-coordinates 410B as input during training. The 3D bones 418B may also be labeled with the image 404, in some instances. However, the unsupervised depth coordinates 412 (also referred to as unsupervised depth features) are not used to label the 3D bones 418A or input into either sub-network. Thus, the sub-networks learn patterns and relationships between the 3D bones 418B and its labels without explicitly supervising the unsupervised depth features 412. This results in the intermediate representation of an individual’s pose (e.g., represented by the x- 408A and y-coordinates 410A) more discriminatory power in the final determination of 3D pose compared to conventional models. The pose estimation model may store the unsupervised depth features 412 and/or other depth cues and use this stored data in estimating the 3D bones 418, but the motion monitoring platform 102 does not explicitly enforce the pose estimation model to do so.

This approach results in several advantages over conventional approaches for pose estimation. Though the features are not supervised, experiments have shown that using unsupervised features in the pose estimation model is significantly superior to only using x- and y-axis features and causes the pose estimation model to render more stable and coherent sequences of estimated poses than previous methods. The use of unsupervised depth coordinates keeps the pose estimation model lightweight compared to other pose estimation techniques, while still allowing the pose estimation model to use more information than just 2D pose to estimate 3D pose.

### Methodologies for Pose Estimation

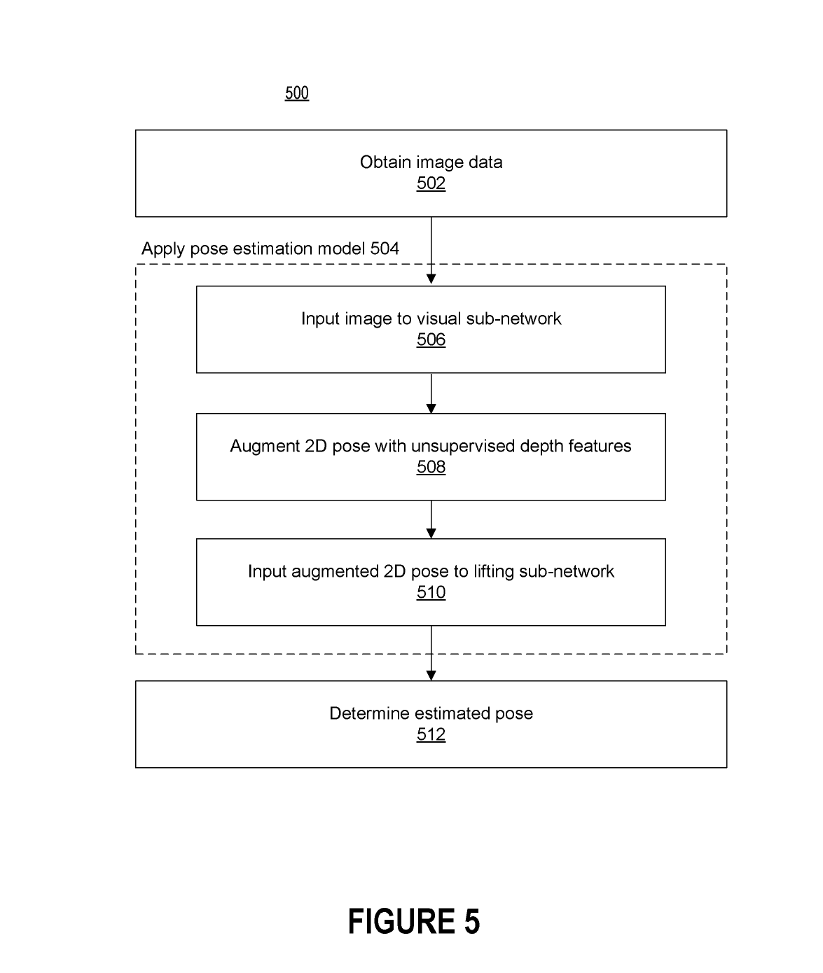

FIG. 5 depicts a flow diagram of a process 500 for determining an estimated pose using a pose estimation model, according to one embodiment. The motion monitoring platform 102 can employ the process 500 as part of guiding a user through a set of physical activities for a session. In some embodiments, the motion monitoring platform 102 can perform additional or alternative steps to those shown in FIG. 5 and/or use additional or alternative modules to those described herein to perform the process 500.

Initially, motion monitoring platform 102 obtains 502 an image 404 of an individual in an environment. The motion monitoring platform 102 may receive the image 404 from an image sensor 210 operating at the computing device 200 running the motion monitoring platform 102 or may receive the image 404 via a network 108 from another computing device. The motion monitoring platform applies 504 a pose estimation model to the image 404.

Within the pose estimation model, the image 404 is input 506 to the visual sub-network 406. The visual sub-network 406 is trained to extract a 2D pose from the image. The visual sub-network 406 can be a neural network or other machine learning model. The 2D pose may be represented by 2D key points, which are x- 408A and y-coordinates 410A corresponding to bones and joints of the individual. The visual sub-network 406 also extracts unsupervised depth features 412 from the image. The dimensions of the unsupervised depth features 412 match the dimensions of the 2D pose in that the unsupervised depth features are mapped in a coordinate system that corresponds to the coordinate system of the 2D pose, such that the unsupervised depth features form a feature map that can augment the feature maps of the 2D pose (e.g., the 2D key points).

The visual sub-network 406 augments 508 the 2D pose with the unsupervised depth features. For example, the pose estimation model may label each associated x 408A and y 410A pair with a corresponding unsupervised depth feature. The augmented 2D pose is input 510 to the lifting sub-network 414. The lifting sub-network 414 can be a neural network with a stack of fully-connected layers, which may increase the capacity of the lifting sub-network 414, and is trained to regress 3D bones 418A based on the input. The lifting sub-network 414 may only receive the outputs of the visual sub-network 406 The lifting sub-network 414 determines 3D bones 418A (represented as 3D points in a 3D coordinate system) and outputs the 3D bones to the motion monitoring model 102. In some instances, the 3D bones 418A include placement of the individual’s joints.

The motion monitoring platform 102 determines 512 an estimated pose of the individual based on the 3D bones. For example, the motion monitoring platform 102 can graph the 3D points representing the 3D bones, create an outline of the individual’s skeleton based on the graph, and compare the outline to internally stored pose data that indicates relationship between bone locations and pose. In some instances, the motion monitoring platform 102 determines locations of joints based on the outline. The motion monitoring platform 102 can further use joint locations to query the database for the pose of the individual. In some instances, the motion monitoring platform 102 may determine that two or more poses match the outline and use a comparison analysis between the outline and the pose data form the database to select a pose with the highest percentage of similarity as the estimated pose.

The process 500 may include additional or alternative steps to those shown in FIG. 5. For example, in some embodiments, the motion monitoring platform 102 can render a visual indicium of the estimated pose on an interface presented on the display mechanism 206 of individual’s computing device 200, so as to visually illustrate the estimated pose to the individual. The motion monitoring platform 102 may update the visual indicum upon receiving a new image and using the pose estimation model to estimate a new pose.

### Processing System

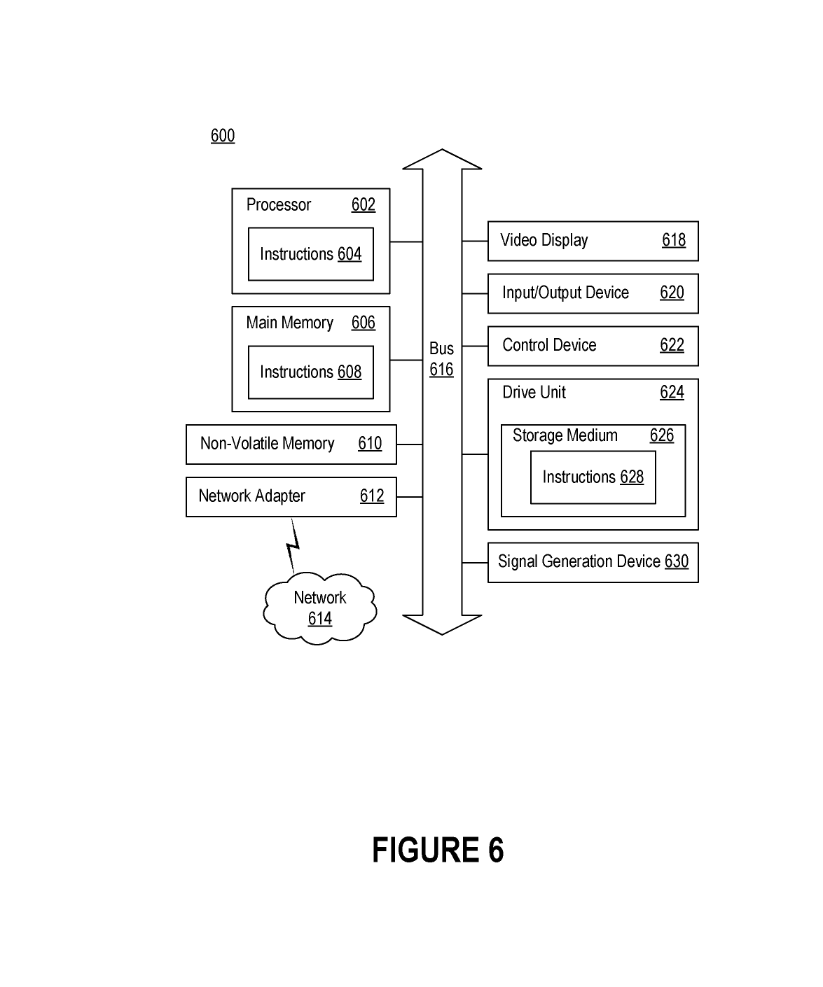

FIG. 6 is a block diagram illustrating an example of a processing system 600 in which at least some operations described herein can be implemented. For example, components of the processing system 600 may be hosted on a computing device that includes a therapy platform (e.g., therapy platform 102 of FIGS. 1 and 2A or therapy platforms 302, 352 of FIGS. 3A-B).

The processing system 600 may include a processor 602, main memory 606, non-volatile memory 610, network adapter 612, video display 618, input/output device 620, control device 622 (e.g., a keyboard or pointing device), drive unit 624 including a storage medium 626, and signal generation device 630 that are communicatively connected to a bus 616. The bus 616 is illustrated as an abstraction that represents one or more physical buses or point-to-point connections that are connected by appropriate bridges, adapters, or controllers. The bus 616, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 606, non-volatile memory 610, and storage medium 626 are shown to be a single medium, the terms “machine-readable medium” and “storage medium” should be taken to include a single medium or multiple media (e.g., a centralized/distributed database and/or associated caches and servers) that store one or more sets of instructions 628. The terms “machine-readable medium” and “storage medium” shall also be taken to include any medium that is capable of storing, encoding, or carrying a set of instructions for execution by the processing system 600.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in a computing device. When read and executed by the processors 602, the instruction(s) cause the processing system 600 to perform operations to execute elements involving the various aspects of the present disclosure.

Further examples of machine- and computer-readable media include recordable-type media, such as volatile memory devices and non-volatile memory devices 610, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 612 enables the processing system 600 to mediate data in a network 614 with an entity that is external to the processing system 600 through any communication protocol supported by the processing system 600 and the external entity. The network adapter 612 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computing device comprising:
a processor; and
a non-transitory computer-readable storage medium storing instructions that, when executed by the processor, cause the processor to perform actions comprising:
obtaining an image of an individual in an environment;
applying a pose estimation model to the image by:
inputting the image to a first sub-network, wherein the first sub-network:
extracts a two-dimensional (2D) pose and unsupervised depth features from the image, wherein dimensions of the unsupervised depth features match dimensions of the 2D pose; and
augments the 2D pose with the unsupervised depth features;
inputting the augmented 2D pose to a second sub-network, wherein the second sub-network is trained to regress 3D bones based on the input; and
determining, based on the 3D bones received from the second sub-network, an estimated pose of the individual in the image.

2. The computing device of claim 1, wherein the first sub-network is a convolutional neural network and the second sub-network is a neural network with a stack of fully connected layers.

3. The computing device of claim 1, wherein the image is labeled with the 2D pose and 3D bones and stored as training data for the pose estimation model.

4. The computing device of claim 1, wherein the unsupervised depth features form a feature map.

5. The computing device of claim 1, the actions further comprising:
training the pose estimation model on historical images labeled with 2D poses and 3D bones.

6. The computing device of claim 1, the actions further comprising:
rendering a visual indicium that is indicative of the estimated pose on an interface presented on a display of the computing device that is accessible to the individual, so as to visually illustrate the estimated pose to the individual.

7. The computing device of claim 1, wherein the dimensions of the 2D pose correspond to a 2D spatial plane defined by the image.

8. A method comprising:
applying, to an image, a pose estimation model that
(i) extracts, with a first sub-network, a two-dimensional (2D) pose,
(ii) extracts unsupervised depth features with dimensions that match the 2D pose,
(iii) augments the 2D pose with the unsupervised depth features, and
(iv) regresses, with a second sub-network, three-dimensional (3D) bones from the 2D pose and the unsupervised depth features.

9. The method of claim 8, wherein augmenting the 2D pose comprises associating unsupervised depth features with 2D key points of the 2D pose.

10. The method of claim 8, wherein the first sub-network is a convolutional neural network and the second sub-network is a neural network with a stack of fully connected layers.

11. The method of claim 8, wherein the image is labeled with the 2D pose and 3D bones and stored as training data for the pose estimation model.

12. The method of claim 8, wherein the unsupervised depth features form a feature map.

13. The method of claim 8, further comprising:
training the pose estimation model on historical images labeled with 2D poses and 3D bones.

14. The method of claim 8, further comprising:
rendering a visual indicium that is indicative of the 3D bones on an interface presented on a display of a computing device that is accessible to the individual, so as to visually illustrate a pose of the 3D bones to the individual.

15. The method of claim 8, wherein the dimensions of the 2D pose correspond to a 2D spatial plane defined by the image.

16. A non-transitory computer-readable storage medium storing instructions that, when executed by a computer processor, cause the computer processor to perform actions comprising:
obtaining an image of an individual in an environment;
applying, to the image, a model that
(i) extracts, with a first sub-network, a two-dimensional (2D) pose of the individual,
(ii) extracts an unsupervised depth feature that has the same dimensions as the 2D pose,
(iii) augments the 2D pose with the unsupervised depth feature, and
(iii) regresses, with a second sub-network, a three-dimensional (3D) skeletal frame from the 2D pose and the unsupervised depth feature; and
causing an interface to display the 3D skeletal frame and feedback related to a pose of the 3D skeletal frame.

17. The non-transitory computer-readable storage medium of claim 16, wherein augmenting the 2D pose comprises associating the unsupervised depth feature with a 2D key point of the 2D pose.

18. The non-transitory computer-readable storage medium of claim 16, wherein the first sub-network is a convolutional neural network and the second sub-network is a neural network with a stack of fully connected layers.

19. The non-transitory computer-readable storage medium of claim 16, wherein the image is labeled with the 2D pose and 3D skeletal frame and stored as training data for the model.

20. The non-transitory computer-readable storage medium of claim 16, the actions further comprising:
training the model on historical images labeled with 2D poses and 3D skeletal frames.
